(19) United States
(12) Patent Application Publication
(10) Pub. No.: US 2014/0244754 A1
(43) Pub. Date: Aug. 28, 2014

(54) DATA MANAGING DEVICE AND METHOD FOR ADDING DATA TO PLURAL TERMINAL DEVICES AND DATA MANAGING PROGRAM

(71) Applicants: Toshiba Tec Kabushiki Kaisha, Tokyo (JP); Kabushiki Kaisha Toshiba, Tokyo (JP)

(72) Inventors: AKIHIRO MIZUTANI, Shizuoka-ken (JP); Kazuhiro Ogura, Kanagawa-ken (JP); Shinji Makishima, Shizuoka-ken (JP); Toshihiro Ida, Shizuoka-ken (JP); Yusuke Hamada, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 14/185,702

(22) Filed: Feb. 20, 2014

(30) Foreign Application Priority Data
Feb. 22, 2013 (JP) 2013-033378

(51) Int. Cl. H04L 29/06

(52) U.S. Cl. CPC H04L 65/403
USPC 709/204

(57) ABSTRACT

A data managing device manages data created in a plurality of terminal devices connected through a network. The data managing device includes a drawing storage unit configured to store added drawing data when the drawing data is added by a first terminal device, and a controller configured to control the drawing storage unit and communicate with the plurality of terminal devices so that the added drawing data is displayed on at least one of the plurality of terminal devices other than the first terminal device if the first terminal device had presenter authority when the drawing data is added.

### CROSS-REFERENCE TO RELATED APPLICATION

This application is based upon and claims the benefit of priority from Japanese Patent Application No. 2013-033378, filed Feb. 22, 2013, the entire contents of which are incorporated herein by reference.

### FIELD

Embodiments described herein relate generally to a data managing device and a data managing program in a conference system.

### BACKGROUND

In the related art, as part of a paperless system, there is a conference system in which a conference is performed by displaying a document file on a personal computer (PC), a tablet terminal device, or the like, without the need for printing out the document file. In addition, there is also a conference system in which memo information such as a comment, or the like, may be input on a manuscript which is used in a conference, and the manuscript and the memo information may be maintained, i.e., saved.

However, there is no protocol to handle the memo information when a presenter is changed in the middle of the conference. Thus, there is a problem in that, it is not possible to make a decision on whether the presentation will continue using the memo information which is input by the previous presenter as it is, or whether the presentation will continue by deleting the memo information which is input by the previous presenter, when a replacement presenter makes a presentation in the middle of the conference.

### DESCRIPTION OF THE DRAWINGS

FIG. 1 is a configuration diagram of an electronic conference system which uses a data managing device, according to an embodiment.

FIG. 2 is a block diagram which illustrates a hardware configuration of a main data managing unit, according to the embodiment.

FIG. 3 is a block diagram which illustrates a hardware configuration of a terminal device, according to the embodiment.

FIG. 4 illustrates a display example of a conference material in the terminal device, according to the embodiment.

FIG. 5 illustrates an adding operation of memo information in the terminal device, according to the embodiment.

FIGS. 6A and 6B illustrate examples of conference information which are managed by a material data managing unit, according to the embodiment.

FIGS. 7A to 7D illustrate examples of data which are stored in an addition database of the terminal device, according to the embodiment.

FIGS. 8A and 8B illustrate examples of presenter data which are stored in a main data managing unit, according to the embodiment.

FIGS. 9A and 9B illustrate examples of data which are stored in the addition database of the terminal device and the main data managing unit, according to the embodiment.

FIG. 10A is a flowchart of operations of the main data managing unit, according to the embodiment.

FIG. 10B is a flowchart of subsequent processes of FIG. 10A.

FIG. 11 is a flowchart of operations of the main data managing unit, according to the embodiment.

### DETAILED DESCRIPTION

Embodiments provide a data managing device and a data managing program in which drawing data which is added to a presentation with a presenter terminal is individually managed in a server, and display or non-display of the drawing data may be controlled by an instruction from the presenter terminal even when a presenter is replaced.

In general, according to one embodiment, a data managing device manages data created in a plurality of terminal devices connected through a network. The data managing device includes a drawing storage unit configured to store added drawing data when the drawing data is added by a first terminal device, and a controller configured to control the drawing storage unit and communicate with the plurality of terminal devices so that the added drawing data is displayed on at least one of the plurality of terminal devices other than the first terminal device if the first terminal device had presenter authority when the drawing data is added.

Hereinafter, embodiments will be described with reference to drawings. In addition, in each figure, the same portions will be given the same reference numerals.

### First Embodiment

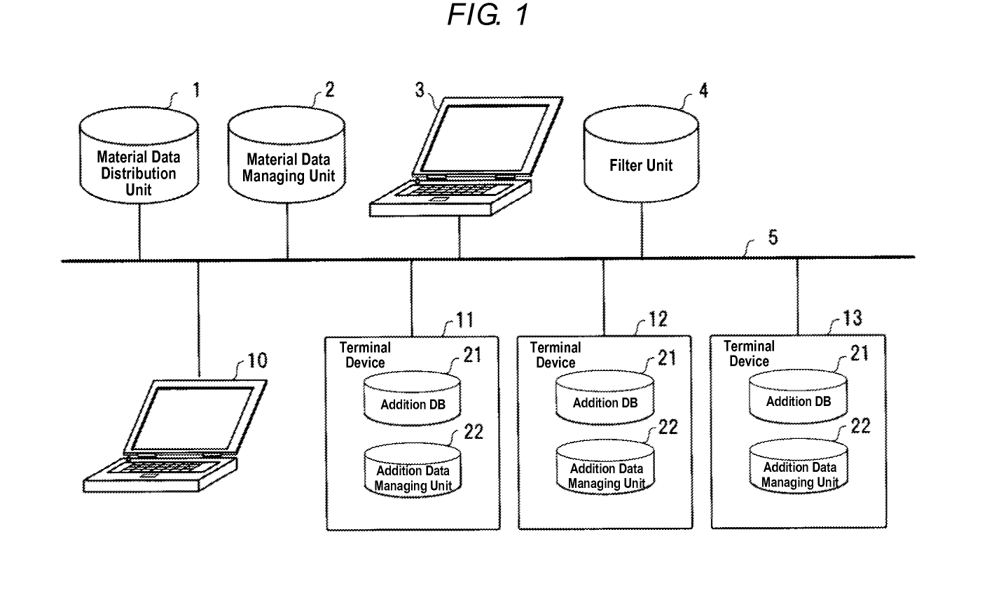

FIG. 1 is a configuration diagram of an electronic conference system which uses a data managing device, according to an embodiment. In the electronic conference system in FIG. 1, a material data distribution unit 1, a material data managing unit 2, a main data managing unit 3, and a filter unit 4 are connected to a network 5 such as a Local Area Network (LAN). In addition, a registering terminal 10, and a plurality of terminal devices 11, 12 and 13 (hereinafter, referred to as terminals) are connected to the network 5.

The material data distribution unit 1 distributes conference material to the terminals 11, 12 and 13. The material data managing unit 2 manages material data in each conference. The main data managing unit 3 is a managing server which configures a data managing device, and manages memo information (drawing data) which is added in the terminals 11, 12 and 13. The filter unit 4 sets conditions for filtering a display of the added drawing data. It is also possible to configure the filter unit 4 in the main data managing unit 3.

The registering terminal 10 creates conference information, and registers the information in the material data managing unit 2. The terminals 11, 12 and 13 are terminal devices which may display the conference information. The terminals 11, 12 and 13 may be a personal computer (PC), or a tablet terminal, for example. In the following descriptions, an example will be described in which a tablet terminal device is used as the terminals 11, 12, and 13.

The terminals 11, 12, and 13 each include an addition database 21 and an addition data managing unit 22. Hereinafter, the addition database 21 will be referred to as an addition DB. The addition DB 21 and the addition data managing unit 22 are provided in each of the terminals 11, 12, and 13. It is also possible to configure the addition DB and the addition data managing unit in an external storage device.

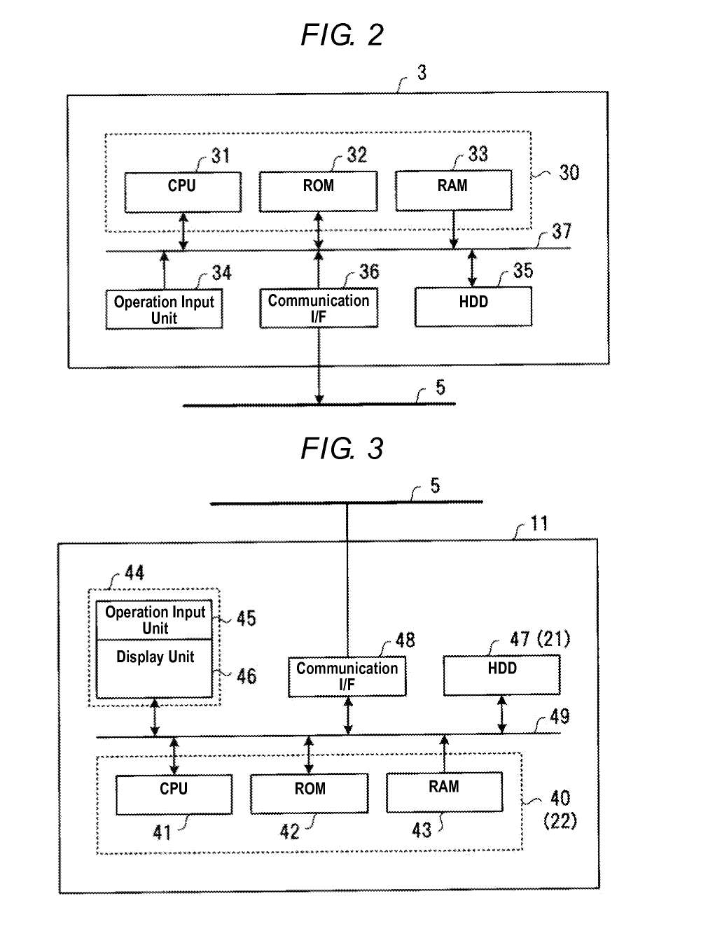

FIG. 2 is a block diagram which illustrates a hardware configuration of the main data managing unit 3. The main data managing unit 3 includes a control unit 30 including a CPU 31 as a controller, a ROM 32, a RAM 33, an operation input unit 34 such as a keyboard, a storage unit such as an HDD 35, and a communication interface (IF) 36. The CPU 31, the ROM 32, the RAM 33, the operation input unit 34, the HDD 35, and the communication interface (IF) 36 are connected to each other through a bus line 37.

The control unit 30 functions as a computer. The CPU 31 controls the entire main data managing unit 3 by reading and executing a program which is stored in the ROM 32, and executes various functions. The RAM 33 temporarily stores various variable data items, image data, or the like, as needed for the functions executed by CPU 31. In addition, the RAM 33 stores drawing data (described later) which is added by the terminals 11, 12 and 13 in a predetermined region, and manages the data. Accordingly, the RAM 33 functions as a drawing storage unit.

The operation input unit 34 receives an operation input from a user. The HDD 35 stores various pieces of information which are processed in the main data managing unit 3. The communication IF 36 performs exchanging (input-output) of data with the registering terminal 10, or the terminals 11, 12, and 13 through the network 5. In addition, the CPU 31 controls display or non-display of added drawing data according to filtering conditions which are set in the filter unit 4.

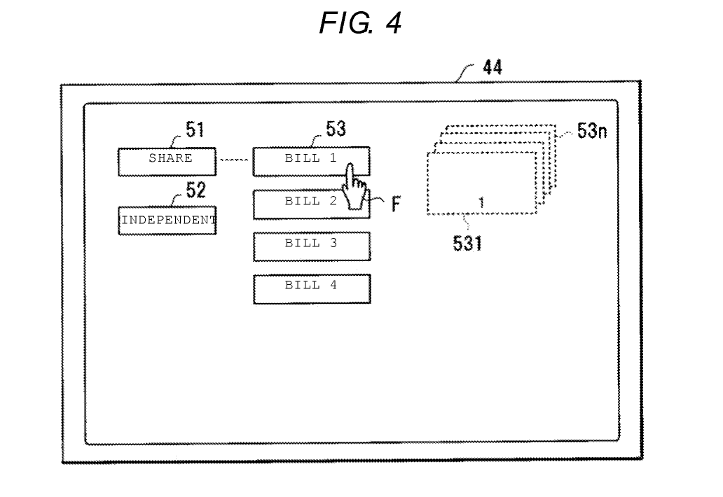

FIG. 3 is a block diagram which illustrates hardware configurations of the terminals 11, 12, and 13. In FIG. 3, the terminal 11 will be representatively described. The terminal 11 includes a control unit 40 including a CPU 41, a ROM 42, and a RAM 43, a display panel 44, a storage unit such as an HDD 47, and a communication interface (IF) 48. The CPU 41, the ROM 42, the RAM 43, the display panel 44, the HDD 47, and the communication IF 48 are connected to each other through a bus line 49.

The CPU 41 controls the entire terminal 11 by reading and executing a program which is stored in the ROM 42. The CPU also executes various functions. The RAM 43 temporarily stores variable data items, image data, or the like, as needed. The control unit 40—including the CPU 41, the ROM 42, and the RAM 43 corresponds to the addition data managing unit 22 in FIG. 1. The display panel 44 is, for example, a touch panel and also functions as an operation input unit 45 which receives input from a user, and a display unit 46. In addition, the operation input unit 45 may receive various inputs when a touch panel is touched by a user using a finger or a touch pen. The operation input unit 45 may be a button, or a key.

The HDD 47 is a storage unit which stores added drawing data (which will be described later), or the like. The HDD 47 corresponds to the addition DB 21 in FIG. 1. The communication IF 48 exchanges (input-output) data with the material data distribution unit 1, the material data managing unit 2, and the main data managing unit 3 through the network 5. The terminal 11 may transmit various requests, received as input through the operation input unit 45, to the main data managing unit 3.

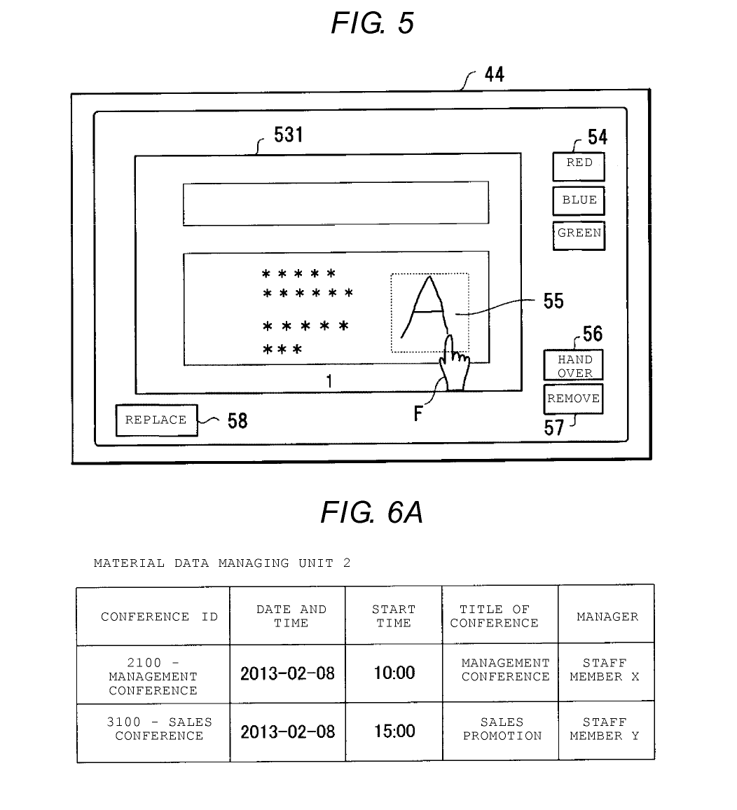

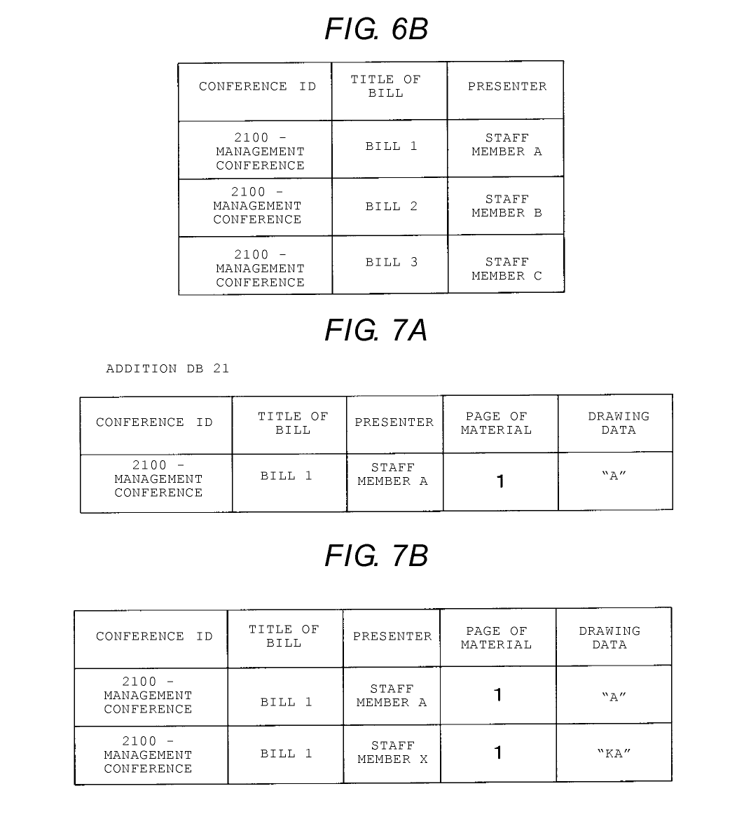

Hereinafter, an operation of a conference system according to the embodiment will be described. FIGS. 4 and 5 show operations of the conference system, including display of conference materials in the terminals 11, 12, and 13, and addition of memo information.

The terminals 11, 12, and 13 may participate in a conference by being connected to the network 5. The terminals 11, 12, and 14 may download a conference material (which is managed by the material data managing unit 2) from the material data managing unit 2. Here, the terminal 11 is representative, and its operations will be described. A user is able to select a screen by touching the display panel 44 of the terminal 11 using a finger F, or perform adding of memo information.

When the terminal 11 has accessed the conference system by connection to the network 5, as illustrated in FIG. 4, a sharing button 51 and an independent button 52, for example, are displayed on the display panel 44 of the terminal 11. The sharing button 51 is used for selecting a material which is to be commonly distributed to users who are participating in the conference, respectively. When the sharing button 51 is touched, submenus are displayed (not shown). Items which are denoted in bills 1 to 4, for example, are displayed by selecting a title of a conference from the menus, thereby selecting a bill. For example, the bill 1 includes material data which includes a plurality of pages 531 to 53n.

FIG. 5 illustrates an example operation in which a material 531 (the first page of the bill 1, which is selected on the terminal 11) is displayed. When a user makes a presentation by operating the terminal 11, the terminal 11 operates as a presenter terminal. In the other terminals 12 and 13, the same screen as that in FIG. 5 is also displayed. It is possible to listen to descriptions of a presenter while viewing a screen, for example, by selecting the bill 1, and displaying the material 531. At this time, the terminals 12 and 13 operate as reader terminals. In addition, in FIG. 5, the presenter terminal 11 may add (draw) memo information by a user touching a screen using the finger F. The added memo information (drawing data) is also displayed on the reader terminals 12 and 13.

When adding the memo information, a selection button 54 for performing a color selection is displayed on a screen, and it is possible for a presenter to perform adding using a desired color when a user selects a color such as a red color, a blue color, a green color, or the like. FIG. 5 illustrates an example in which, memo information 55 (drawing data) of “A”, for example, is added. In an actual conference, a notable portion of the displayed material 531 may be surrounded with a circle, may be underlined, or may be annotated with various memos. However, for easy description, an example in which the memo information 55 of “A” is added is illustrated here. The memo information “A” added by a presenter A includes drawing objects such as “-”, “|”, and “NO”. Such drawing objects are managed in a drawing page unit.

The added memo information 55 is stored in the addition DB 21 of the presenter terminal 11, and is managed by the addition data managing unit 22. In addition, the added memo information 55 is transmitted to the main data managing unit 3 where it is subject to further management.

In addition, as illustrated in FIG. 5, for example, a handover button 56 and a deletion button 57 are displayed on a screen of the presenter terminal 11, and on the reader terminals 12 and 13. A subsequent presenter selects either the handover button 56 or the deletion button 57, in order to change a presenter in the middle of the conference. When the added memo information 55 is ready to be handed over, a user of the reader terminal 12 or 13 hands over the presentation by selecting the handover button 56 which is displayed on the screen. When the added memo information 55 is to be removed, the deletion button 57 is selected.

Hereinafter, detailed operations of the conference system according to the embodiment will be described by concentrating on the main data managing unit 3 and the terminals 11 to 13.

First, when describing the conference system, the participants in the conference are a presenter and at least one reader. Here, a terminal which is operated by the presenter among the terminals 11 to 13 is a presenter terminal, and terminals other than that are reader terminals.

A “sharing” mode is present in the presenter terminal, and the “sharing” and “independent” modes are present in the reader terminal. In a case of the “sharing” mode, drawing data which is added by the presenter terminal is sequentially reflected in the reader terminal. However, it is not possible to add data to the conference using the reader terminal. The “independent” mode is active in an offline state of a terminal. While the reader terminal is in independent mode, any drawing data which is added by the reader terminal is stored in the addition DB 21 and is accumulated in the main data managing unit 3, but is not reflected in other reader terminals.

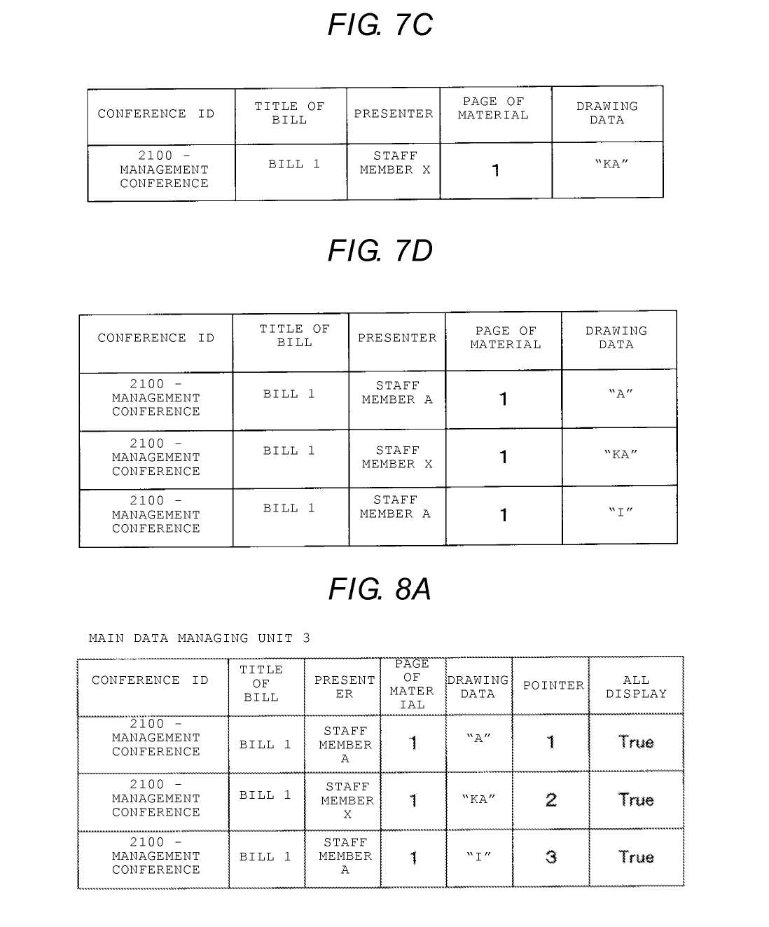

In the system shown in FIG. 1, material data for a conference which is created in the registering terminal 10 is sent to the material data managing unit 2, and is managed. FIGS. 6A and 6B illustrate examples of conference information which is managed in the material data managing unit 2. FIG. 6A illustrates conference information, and FIG. 6B illustrates a detail of the conference information.

As illustrated in FIG. 6A, the conference information includes, for example, conference ID, date and time for a conference, a starting time, a title of a conference, and a manager. It is possible to designate a plurality of managers in the conference. For example, when a title of the conference is a “management conference”, items may include a bill 1, a bill 2, a bill 3, and presenters of the respective bills are included in the details thereof, as illustrated in FIG. 6B. The identity of the presenters may be subject to a default setting. A presenter may be changed every time that there is a request for obtaining a presenter authority after starting the conference. In addition, the registering terminal 10 registers materials relating to each of bills 1 to 3 collectively, in the material data managing unit 2.

When receiving a request for the conference materials from the terminals 11, 12, or 13, the material data distribution unit 1 sends data from the material data managing unit 2 to the requesting terminal. A screen for selecting a conference (e.g., “management conference” or “sales conference”) to participate in is displayed on the terminals 11, 12, and 13, and as illustrated in FIG. 4. When the management conference is selected, for example, a screen for selecting bills 1 to 4 of the management conference is displayed. In addition, when selecting the “bill 1”, the material 531 relating to the bill 1 is displayed, as illustrated in FIG. 5. In addition, as illustrated in FIG. 5, a presenter may add (draw) the memo information by operating the presenter's own terminal.

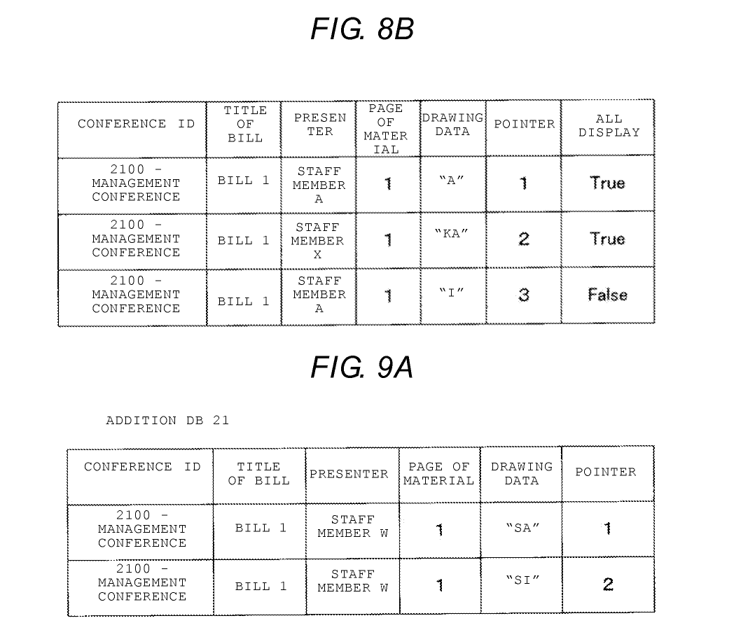

FIGS. 7A to 7D illustrate examples of data items which are stored in the addition DB 21 of the terminals 11 to 13 under control of the main data managing unit 3. FIG. 7A contains items including: a conference ID, a title of a bill, a presenter, a material page, and drawing data. For example, with respect to bill 1 of a management conference, when a “staff member A” as a presenter makes a presentation, and memo information of “A” is added onto the material page 1 in the middle of the presentation, drawing data “A” is stored in the addition DB 21. That is, as shown in FIG. 7A, memo information “A” is added to the material 531 on the first page which is illustrated in FIG. 5, and is stored as drawing data “A”.

FIG. 7B illustrates an example of data which is stored in the addition DB 21 of the presenter terminal when a presenter is changed to a staff member X from the staff member A. When the staff member X wants to make a presentation while the staff member A is making a presentation, the staff member X (for example, a user of the terminal 12) requests the main data managing unit 3 for replacement of a presenter. The terminal 12 then becomes a presenter terminal. For example, the request for replacement of the presenter is transmitted to the main data managing unit 3 by touching a replacement button 58 (which is displayed on the screen in FIG. 5), and the staff member X then obtains a presenter authority.

The replacement presenter “staff member X” may select whether to make a presentation including the memo information “A” which was added by the previous presenter “staff member A” as-is, or to make a presentation by removing the memo information “A” added by the previous presenter “staff member A”.

For example, the replacement presenter may touch any one of the buttons 56 and 57 in FIG. 5. When the handover button 56 is selected, the memo information “A” is added to the material 531, and the display is changed accordingly.

In addition, the presenter “staff member X” may add the presenter's own memo information to the material 531. Here, when memo information “KA” is added, for example, as illustrated in FIG. 7B, both the memo information “A” and “KA” are added to the material 531 on the first page, and are stored in the addition DB 21 of the presenter terminal 12 as drawing data “A” and “KA”.

In addition, when the presenter “staff member X” touches the deletion button 57 in FIG. 5, the memo information “A” (which was previously added to the material 531) is deleted, and only the material 531 is displayed on a screen of each of the terminals 11 to 13. When making the presentation based on the material in which the memo information “A” is deleted, for example, when the memo information “KA” is added, as illustrated in FIG. 7C, only the memo information “KA” is added to the material 531 on the first page in the addition DB 21 of the presenter terminal 12. The memo information “KA is also stored as the drawing data “KA”. In addition, both the memo information “A” and “KA” which are added by the presenters “staff member A” and the “staff member X” are stored in the main data managing unit 3 regardless of the selection of the handover button 56 and the deletion button 57.

FIG. 7D illustrates an example in which the “staff member A” obtains the presenter authority again after the presentation of the presenter “staff member X.” The “staff member A” makes a presentation by handing over the memo information “KA” which was added by the “staff member X”, and newly adds memo information “I”. At this time, pieces of memo information “A”, “KA”, and “I” are added to the material 531 on the first page, and are stored as drawing data items “A”, “KA”, and “I” in the addition DB 21 of the presenter terminal 11. The data items in FIG. 7D become a list at a point of time when the conference is ended.

As described above, the main data managing unit 3 displays the material by setting the added memo information to display or non-display with respect to terminals of other participants, depending on an operation (selecting “handover” or “remove”) from the presenter terminal. In addition, all of the pieces of memo information which are added by the presenter terminal are stored in the main data managing unit 3, and may be presented along with the material data when there is a request from the reader terminals 11 to 13 thereafter.

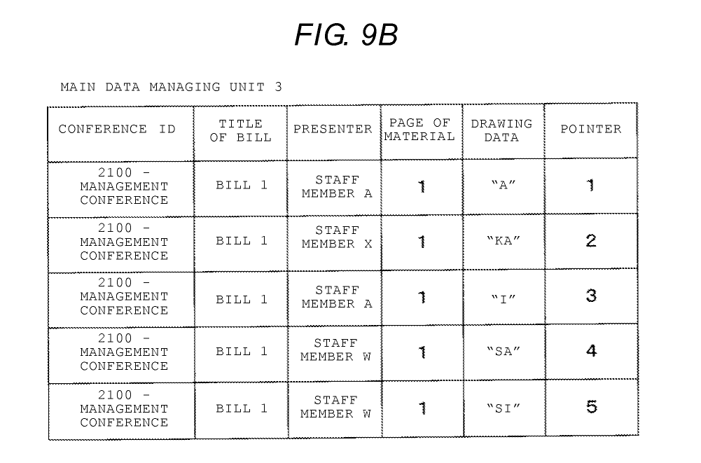

FIGS. 8A and 8B illustrate examples of presenter data which is stored in the main data managing unit 3. The presenter data in FIGS. 8A and 8B includes a pointer and all display data, in addition to a conference ID, a title of a bill, a presenter, a material page, and drawing data.

In FIGS. 8A and 8B, whether or not to display the pieces of memo information of “A”, “KA”, and “I” (which were added by the staff member A and staff member X in FIG. 7D) in all the terminals 11 to 13 which are connected to the conference system is set in the item of “all display.” When the “all display” item is “True,” the pieces of memo information are displayed. When the “all display” item is “False,” the pieces of memo information are not displayed. In addition, the “pointer” denotes adding order of drawing data, and denotes that “A” is added first, “KA” is added second, and “I” is added third.

That is, the memo information “A” which is drawn by the presenter “staff member A” is added to the main data managing unit 3, and is allocated with a pointer 1. A pointer is added every time the presenter authority is changed. Accordingly, the memo information “KA” which is drawn by the presenter “staff member X” is added to the main data managing unit 3, and is allocated with a pointer 2.

In FIG. 8A, since “True” is set to all of the drawing data items “A,” “KA,” and “I,” those pieces of memo information are displayed on all of the terminals 11 to 13. In FIG. 8B, since “False” is set to “I,” and “True” is set to the drawing data items “A” and “KA,” only pieces of memo information of “A” and “KA” are displayed on the terminals 11 to 13, and the memo information of “I” is not displayed.

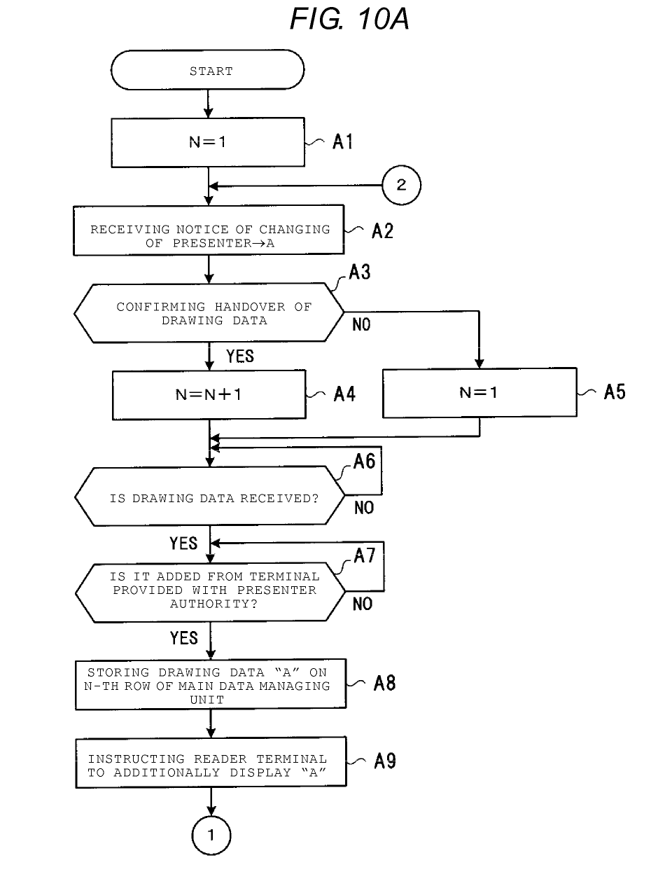

FIGS. 9A and 9B illustrate examples of data items which are stored in the addition DB 21 when the terminals 11 to 13 add memo information to the material in an offline state. The terminals 11 to 13 may also display a material which is obtained in advance (for example, 531) on a screen, and add memo information in an offline state, i.e., a state of not being connected to the network 5. Since a terminal in the offline state is not connected to other terminals, the terminal is in an “independent” mode. Here, the terminal 13 is assumed to be in the offline state.

FIG. 9A includes items such as a conference ID, a title of a bill, a presenter, a material page, drawing data, and a pointer. For example, when “staff member W” adds pieces of memo information of “SA” and “SI” on the first page of the material using the terminal 13 in an offline state, drawing data items “SA” and “SI” are stored in the addition DB 21 of the terminal 13.

FIG. 9B illustrates an example of data which is stored in the main data managing unit 3 when the terminal 13 is connected to the network 5, i.e., when the terminal 13 is in the online state. When the terminal 13 is in an online state, drawing data which is stored in the addition DB 21 at the time of the online state is added to and stored in the main data managing unit 3. A pointer is added to the end of a pointer which is currently stored as illustrated in FIG. 9B. In addition, when the main data managing unit 3 has a timer function, the pointer may be reset based on a point of time when the terminal 13 transitions from the offline state to the online state (i.e., when the terminal 13 is connected to the network 5).

Adding memo information only on the first page of the material is described in the above described example. However, as a matter of course, it is possible to perform adding and managing, similarly, even when a page of the material is changed.

In addition, in the conference system according to the embodiment, it is also possible to select a display, or the like, for a reader terminal which is changed to an online state from an offline state. For example, consider the memo information (drawing data) which is displayed by the current presenter “staff member A” and is displayed on the reader terminal 13 of the “staff member W.” When the reader “staff member W” shares the conference, all of the pointers are obtained from the main data managing unit 3 as drawing data items, and are then transmitted to the reader terminal 13 of the “staff member W.” In the reader terminal 13 of the “staff member W,” the above described memo information (drawing data) is stored in the addition DB 21, is kept in the reader terminal 13 of the “staff member W,” and is displayed.

In addition, when the presenter is changed from “staff member A” to “staff member X,” and when memo information of the presenter “staff member X” is read, only memo information corresponding to the pointer 2 of the presenter “staff member X” is obtained from the main data managing unit 3 as drawing data. The memo information is then transmitted to the reader terminal 13 of the “staff member W.” The memo information corresponding to the pointer 2 in the reader terminal 13 is stored in the addition DB 21, is kept in the reader terminal 13 of the “staff member W,” and is displayed. Accordingly, it is possible to read memo information of each user.

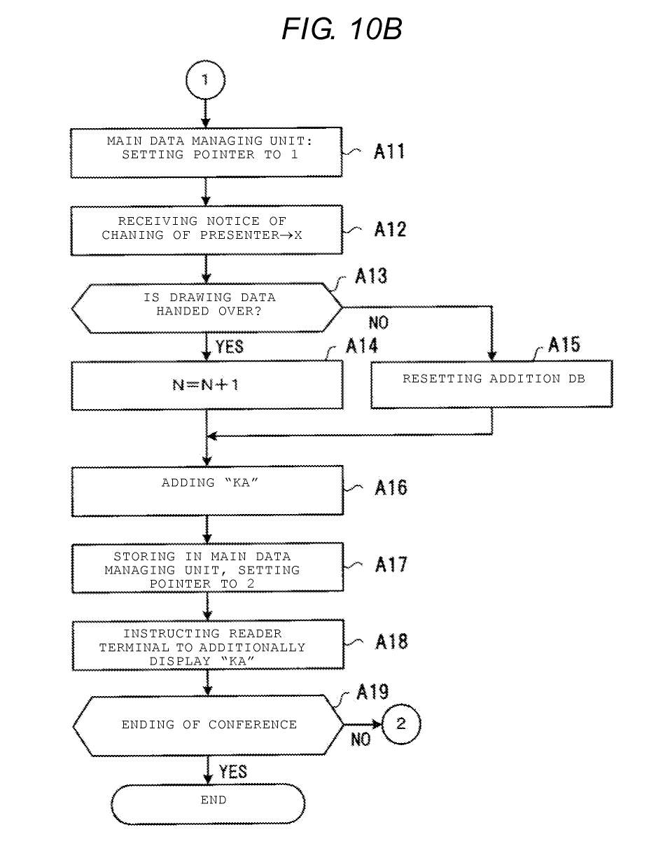

FIGS. 10A and 10B are flowcharts of operations in the main data managing unit 3.

In FIG. 10A, the CPU 31 initializes the number of rows N so as to be N=1 in Act A1. In Act A2, the CPU 31 receives notice of changing of a presenter from any one of the terminals 11 to 13. For example, when receiving notice from the terminal 11 which is operated by the “staff member A”, the CPU 31 makes the terminal 11 function as the presenter terminal. The CPU 31 determines whether or not the presenter terminal 11 hands over the drawing data which is added by the previous presenter in Act A3. For example, when the presenter terminal 11 selects the handover button 56, that is, when the CPU 31 receives handover information from the presenter terminal 11 (YES in A3), the process proceeds to Act A4, and the CPU 31 sets the number of rows N to N+1. In addition, when the presenter terminal 11 selects the deletion button 57, that is, when the CPU 31 receives information of removing the handover information from the presenter terminal 11 (NO in A3), the number of rows N is reset to N=1 in Act A5, and the process proceeds to Act A6.

In Act A6, the CPU 31 determines whether or not the drawing data (memo information) is received in the presenter terminal 11. When it is determined that the drawing data is received in Act A6 (YES in A6), the CPU 31 determines whether or not the received drawing data is added from a terminal to which a presenter authority is given in Act A7.

In the case of drawing data which is added by the terminal to which the presenter authority is given (YES in A7), the CPU 31 stores, for example, the drawing data “A” in the N-th row in a predetermined region of the RAM 33 in Act A8. In Act A9, the CPU 31 instructs the reader terminals 12 and 13 excluding the presenter terminal 11 to store the drawing data “A” in the addition DB 21, and to display the drawing data on the display panel 44. In contrast, memo information which is added by a reader terminal with no presenter authority is not displayed on other terminals. Alternatively, the CPU 31 may perform controlling so that memo information may not be added by a reader terminal that does not have presenter authority.

In the subsequent process in FIG. 10B, the CPU 31 sets the pointer 1 to the drawing data “A” which is stored in the N-th row in a predetermined region of the RAM 33, in Act A11. In addition, when the CPU 31 receives notice of changing of the presenter from one of the terminals 12 and 13 in Act A12 (for example, when receiving notice from the terminal 12 which is operated by the “staff member X”), the terminal 12 functions as a presenter terminal. The CPU 31 determines whether or not the drawing data which is added by the previous presenter is handed over to the presenter terminal 12 in Act A13.

When the drawing data is handed over in Act A13 (YES in A13), the process proceeds to Act A14, and the CPU 31 proceeds to Act A16 by setting the number of rows N to N+1. In addition, when the drawing data of the previous presenter is not handed over, the addition DB 21 of the presenter terminal 12 is reset in Act A15, and the process proceeds to Act A16.

When drawing data “KA” is added, for example, in the presenter terminal 12 at the timing of Act A16, the CPU 31 receives the drawing data “KA”. In the subsequent Act A17, the CPU 31 stores the drawing data “KA” in the (N+1)th row in a predetermined region of the RAM 33, and sets the pointer to 2. In Act A18, the CPU 31 instructs the reader terminals 12 and 13 to additionally display the drawing data “KA” on the display panel 44. In addition, the presenter terminal 12 adds the drawing data “KA” to the addition DB 21 and stores the data therein at the timing of Act A18. In Act A19, the CPU 31 determines whether or not the conference is ended, and ends the process when the conference is ended. The CPU 31 proceeds to Act A2 in FIG. 10 when the conference is not ended, and repeats the Acts as described above.

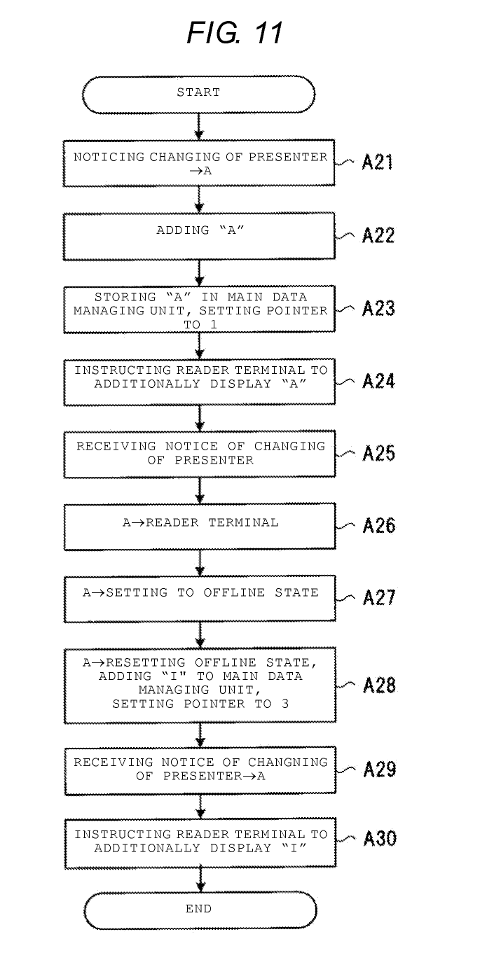

FIG. 11 is a flowchart of operations in the main data managing unit 3. FIG. 11 illustrates an example of an operation when the presenter “staff member A” becomes a reader, and then becomes a presenter again. In this example, operations in the terminal 11 will be described.

In Act A21, the CPU 31 receives notice of changing of a presenter from the terminal 11 (“staff member A”). In this example, the terminal 11 becomes a presenter terminal. In Act A22, when the “staff member A” adds the drawing data “A” by using the presenter terminal 11, the CPU 31 receives information of the drawing data “A” from the presenter terminal 11.

In Act A23, the CPU 31 stores the drawing data “A” in a predetermined region of the RAM 33, and sets the pointer to 1. In addition, In Act A24, the CPU 31 instructs the reader terminal to display the added drawing data “A.”

In the subsequent Act A25, when the CPU 31 receives the notice of changing of a presenter from other terminals (for example, terminal 12 of “staff member X”), the CPU 31 changes the terminal 11 from a presenter terminal to a reader terminal in Act A26. When it is assumed that the reader terminal 11 becomes the offline state in Act A27, the CPU 31 stores the fact that the reader terminal 11 is in the offline state in a predetermined region of the RAM 33. Thereafter, it is assumed that the reader terminal 11 adds the drawing data “I”, for example, in the independent mode. When the reader terminal 11 is the online state again, in Act A28, the CPU 31 clears “the fact that the reader terminal 11 is in the offline state” from the predetermined region of the RAM 33. The CPU then stores the added drawing data “I” in a predetermined region of the RAM 33 by adding the drawing data, and sets the pointer to 3.

In the subsequent Act A29, the CPU 31 receives notice of changing of a presenter again from the terminal 11 (“staff member A”). Here, the terminal 11 becomes a presenter terminal again. In Act A30, the CPU 31 instructs other terminals 12 and 13 to display the added drawing data “I.”

According to the first embodiment which is described above, it is possible to display drawing data which is added by a terminal with respect to other terminals. In addition, it is possible to select whether or not to make a presentation with memo information that was added by the previous presenter.

### Second Embodiment

In the first embodiment, an example is described in which, when changing a presenter, a new presenter selects whether to make a presentation by handing over memo information which was added by the previous presenter, or to make a presentation by removing the memo information, by touching the handover button 56, or the deletion button 57, for example. However, in a second embodiment, whether to hand over the memo information (drawing data), or to remove the memo information is selected using a filter unit 4.

Specifically, as illustrated in FIG. 5, when memo information is added, a selection button 54 for selecting a color is displayed, and it is possible for a user to select a color such as a red color, a blue color, or a green color. In the filter unit 4, it is possible to set conditions in advance so that a presentation is performed by handing over the memo information which was added by the previous presenter when memo information was added using a red color, for example. Likewise, the presentation is performed by removing the memo information which was added by the previous presenter when the memo information was added using a blue color. The main data managing unit 3 determines a color of the memo information which was added by the presenter terminal, and displays a material by setting the added memo information for display or not for display on the other reader terminals.

In this manner, by selecting a color of the added drawing data, it is possible to select whether or not to make the presentation with the memo information which was added by the previous presenter.

In addition, in the filter unit 4, it is also possible to set whether to make the presentation by handing over the memo information which was added by the previous presenter, or to make the presentation by removing the memo information. For example, an elapsed time from the start time of the conference can be counted using a timer, and the presentation is made by including (handing over) memo information which was added by the previous presenter before a certain time period passes, and by removing memo information which was added by the previous presenter after the time period. The main data managing unit 3 determines a time when the memo information is added by the presenter terminal, and displays a material by setting the added memo information for display or not on the reader terminal.

Therefore, according to the second embodiment, when an adding process is executed based on set conditions (added color, or time when added) of the filter unit 4, it is possible to set the memo information which is added to other reader terminals to display or not display according to contents of the process which is executed. For example, it is possible to set to display or not display according to time (for example: drawing data which is added ten minutes after the start of the presentation, drawing data which is added ten minutes before the end of the presentation, or drawing data which is added between ten minutes after the start and ten minutes before the end of the presentation).

In the embodiments, any of the processes described above can be accomplished by a computer-executable program, and this program can be embodied in a non-transitory computer-readable memory device. In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above. Furthermore, based on an instruction in the installed program, an OS (operating system) of the computer, or MW (middleware software), such as database management software or network, may execute one or more parts of the processes described above to realize the embodiments.

According to the above described embodiment, it is possible to provide drawing data which a presenter aims to share with a reader even when a presenter is switched in a conference.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data managing device which manages data created in a plurality of terminal devices connected through a network, the device comprising:
a drawing storage unit configured to store added drawing data when the drawing data is added by a first terminal device; and
a controller configured to control the drawing storage unit and communicate with the plurality of terminal devices so that the added drawing data is displayed on at least one of the plurality of terminal devices other than the first terminal device if the first terminal device had presenter authority when the drawing data is added.

2. The device according to claim 1, wherein the drawing storage unit is configured to store a new drawing data when the presenter authority is passed from the first terminal device to a second terminal device and the new drawing data is added by the second terminal device.

3. The device according to claim 2, wherein the controller is configured to receive a selection on whether to display, on the at least one terminal device other than the first terminal device, the drawing data added by the first terminal device, or to display the new drawing data with on at least one terminal device other than the second terminal device.

4. The device according to claim 3, wherein the selection is received from one of the plurality of user terminals that has the presenter authority.

5. The device according to claim 1, wherein the added drawing data is displayed on at least one of the plurality of terminal devices as additional content to a current presentation.

6. The device according to claim 1, wherein the controller is configured to control the drawing storage unit and communicate with the plurality of terminal devices so that the added drawing data is displayed on at least one of the plurality of terminal devices other than the first terminal device when the controller receives a selection from a second terminal device that has the presenter authority to display the added drawing data.

7. The device according to claim 1, further comprising:
a filter configured to compare the added drawing data to a predetermined criteria, wherein
the controller is configured to control the drawing storage unit and communicate with the plurality of terminal devices so that the added drawing data is displayed on at least one of the plurality of terminal devices other than the first terminal device if the added drawing data satisfies the predetermined criteria.

8. A non-transitory computer readable medium storing a data managing program which manages data created in a plurality of terminal devices connected through a network, the program causing a computer to perform a method comprising the steps of:
storing in a storage device drawing data added by a first terminal device;
determining that the first terminal device had presenter authority when the drawing data was added; and
controlling the storage device and communicating with the plurality of terminal devices so that the added drawing data is displayed on at least one of the plurality of terminal devices other than the first terminal device.

9. The non-transitory computer readable medium according to claim 8, wherein the method further comprises the step of:
storing in the storage device new drawing data added by the second terminal device when the presenter authority is passed from the first terminal device to a second terminal device.

10. The non-transitory computer readable medium according to claim 9, wherein the method further comprises the step of:
receiving a selection on whether to display, on the at least one terminal device other than the first terminal device, the drawing data added by the first terminal device or to display the new drawing data with on at least one terminal device other than the second terminal device.

11. The non-transitory computer readable medium according to claim 10, wherein the selection is received from one of the plurality of user terminals that has the presenter authority.

12. The non-transitory computer readable medium according to claim 8, wherein the added drawing data is displayed on at least one of the plurality of terminal devices as additional content to a current presentation.

13. The non-transitory computer readable medium according to claim 8, wherein the method further comprises the steps of:
receiving a selection from a second terminal device having the presenter authority to display the added drawing data; and
controlling the storage device and communicating with the plurality of terminal devices so that the added drawing data is displayed on at least one of the plurality of terminal devices other than the first terminal device.

14. The non-transitory computer readable medium according to claim 8, wherein the method further comprises the step of:
storing in the storage device new drawing data added by a second terminal device;
comparing the new drawing data to a predetermined criteria; and
controlling the storage device and communicating with the plurality of terminal devices so that the added drawing data is displayed on at least one of the plurality of terminal devices other than the first terminal device when the added drawing data satisfies the predetermined criteria.

15. A method of managing data created in a plurality of terminal devices connected through a network, the method comprising the steps of:
storing in a storage device drawing data added by a first terminal device;
determining that the first terminal device had presenter authority when the drawing data was added; and
controlling the storage device and communicating with the plurality of terminal devices so that the added drawing data is displayed on at least one of the plurality of terminal devices other than the first terminal device.

16. The method according to claim 15, further comprising the step of:
storing in the storage device new drawing data added by the second terminal device when the presenter authority is passed from the first terminal device to a second terminal device.

17. The method according to claim 16, further comprising the step of:
receiving a selection on whether to display, on at least one terminal device other than the second terminal device, the new drawing data.

18. The method according to claim 17, wherein the selection is received from one of the plurality of user terminals that has the presenter authority.

19. The method according to claim 15, wherein the added drawing data is displayed on at least one of the plurality of terminal devices as additional content to a current presentation.

20. The method according to claim 15, further comprising the steps of:
storing in the storage device new drawing data added by a second terminal device;
comparing the new drawing data to a predetermined criteria and determining that the new drawing data satisfies the predetermined criteria; and
controlling the storage device and communicating with the plurality of terminal devices so that the new drawing data is displayed on at least one of the plurality of terminal devices other than the second terminal device.
